(19) United States
(12) Patent Application Publication
(10) Pub. No.: US 2008/0240651 A1
(43) Pub. Date: Oct. 2, 2008

(54) Silicon waveguide dispersion compensator using optical phase conjugation

(76) Inventors: Haisheng Rong, Fremont, CA (US); Simon Ayotte, Saint-Augustin (CA); Mario Paniccia, Santa Clara, CA (US)

Correspondence Address: INTEL CORPORATION;c/o INTELLEVATE, LLC, P.O. BOX 52050, MINNEAPOLIS, MN, 55402, US

(21) Appl. No.: 11/729,080

(22) Filed: Mar. 27, 2007

(51) Int. Cl. G02B 6/26

(52) U.S. Cl. 385/27

(57) ABSTRACT

In the absence of using any chromatic dispersion compensation technique, it may be difficult to detect the transmitted data over long distances at the receiving end. Embodiments utilize the optical phase conjugation (OPC) property in silicon waveguides to compensate chromatic dispersion effect in optical fibers.

### FIELD OF THE INVENTION

Embodiments of the invention relate generally to optical communications and, more particularly, to a dispersion compensator that may be used in an optical communications network.

### BACKGROUND INFORMATION

Fiber-optic networks are increasingly being used in many industries, most notably telecommunications and computer networks. Transmission speeds and distances can at times, however, be limited based on various factors. One of these factors is chromatic dispersion, which occurs when a pulse of light traveling down an optical fiber broadens.

Such pulse broadening typically occurs as different wavelength components or colors within the pulse move at different speeds along the fiber, with the longer wavelength components traveling faster than the shorter wavelength components. Thus, a pulse may broaden and ultimately may overlap with another pulse, thereby distorting the data in a signal. This effect may become increasingly pronounced at high bit rates, as additional factors may contribute to chromatic dispersion (e.g., temperature, humidity, aging, and stress of the fiber).

FIG. 1A shows an eye diagram of a 40 Gbps pseudo random bit sequence (PRBS) signal before transmission. As shown in FIG. 1 B, after just 20 kilometers (km) of transmission through a fiber, chromatic dispersion distorts the signal. As illustrated, the eye diagram for the 40 Gbps signal is completely closed and may render it indecipherable. Longer transmission distances further exacerbate the distortion.

In an effort to reduce chromatic dispersion and allow for longer transmission distances and greater throughput of data, several techniques are used. One technique is to use a dispersion compensating fiber (DCF) that can introduce sufficient negative dispersion into the transmission link thereby offsetting the positive dispersion accumulated by the pulse traveling through the fiber. However, a given portion of fiber generally requires a unique length of DCF in order to provide the correct amount of compensation. As such, DCFs are not readily tunable as changing properties of a DCF often requires changing the DCF length itself, which is a process that can be time-consuming and inefficient.

Another technique that is often used includes the use of dispersion compensation gratings. One type of grating is a chirped in-fiber Bragg grating, which reflects each wavelength component at different points to compensate a dispersed pulse. Like DCFs, however, the amount of dispersion compensation provided cannot be adjusted easily. Moreover, the gratings may sometimes over-compensate or under-compensate at certain frequencies.

Accordingly, chromatic dispersion reduces the efficiency of fiber optic networks by limiting transmission distances and throughput of data. Known methods to solve this problem such as use of DCF and dispersion gratings, may have drawbacks, such as not being easily adjusted and/or not providing a suitable amount of compensation.

### BRIEF DESCRIPTION OF THE DRAWINGS

FIG. 1A is an eye diagram of a 40 Gbps PRBS signal prior to fiber transmission;

FIG. 1 B is an eye diagram of the same 40 Gbps signal shown in FIG. 1A after 20 km of transmission in fiber illustrating the degrading effects of chromatic dispersion;

FIG. 2 is a block diagram of a chromatic dispersion compensation technique using silicon based optical phase conjugation according to one embodiment of the invention;

FIG. 3 is a diagram showing a measured optical spectrum of the FWM signals after silicon optical conjugator

FIG. 4 is a scanning electron microscope image of a PIN waveguide cross-section such as may be utilized by the embodiments of the present invention to mitigate chromatic dispersion;

FIG. 5A is an eye diagram of the 40 Gbps PRBS signal before transmission as shown in FIG. 1A;

FIG. 5B is the same signal as shown in FIG. 5A after 120 km of transmission using optical phase conjugation according to one embodiment of the invention; and

FIG. 5C is the same signal as shown in FIGS. 5A and 5B after 320 km of transmission using optical phase conjugation showing minimal distortion.

### DETAILED DESCRIPTION

In the absence of using any chromatic dispersion compensation technique, it may be difficult to detect the transmitted data over long distances at very high data rates (i.e. >>10 Gb/s) at the receiving end. Embodiments utilize the optical phase conjugation (OPC) property in silicon waveguides to compensate chromatic dispersion effect in optical fibers. This enables high-speed optical data to propagate over long distance as for example in metro and long haul communication networks. In one embodiment the silicon based OPC may be placed near the middle of an optical link (or mid-span) to realize chromatic dispersion compensation.

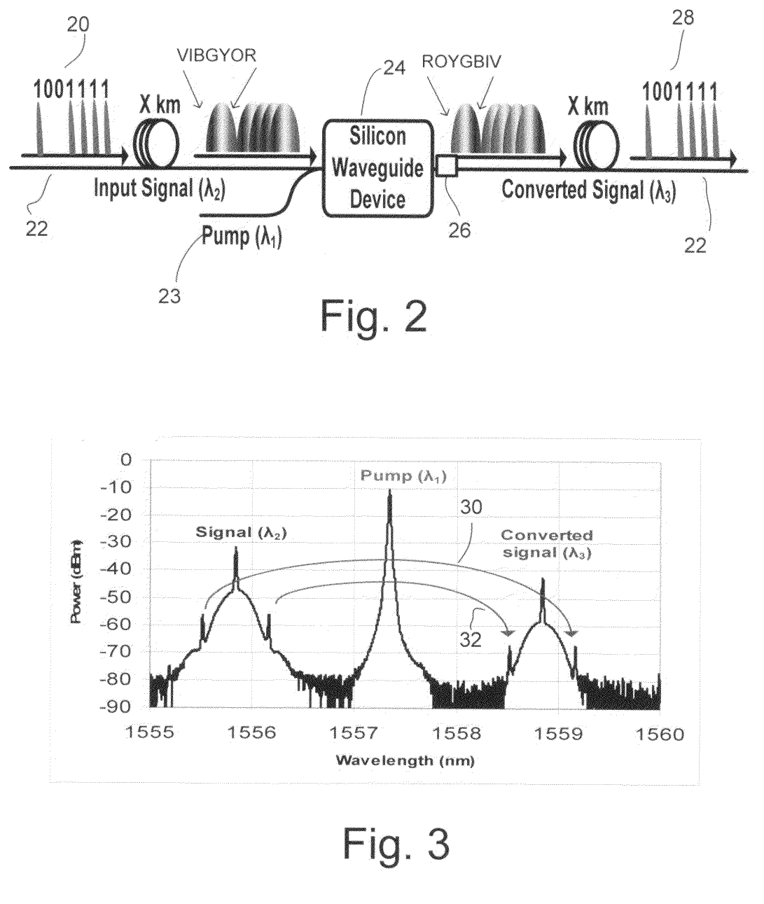

The OPC function may be achieved through four-wave mixing (FWM), a nonlinear optical effect in silicon. Referring now to FIG. 2, there is shown a block diagram of an optical transmission link. An input signal centered at wavelength λ2 comprises data 20 launched down a fiber 22. The fiber may have a length of X km, where X may be for example on the order of 300-400 kilometers. This is of course just an example as the length of the fiber 22 may be longer or shorter depending on the application. The narrow pulses of data 20 comprise a range of wavelengths centered at λ2. This may be illustrated in the visible spectrum as ranging from red, orange, yellow, green, blue, indigo, and violet (ROYGBIV), or, more generally, from red to blue. During the transmission through X km of fiber 22, longer wavelength components (red) travel faster than shorter wavelength components (blue) and the pulses are spread in time, causing signal distortion.

According to embodiments, a silicon waveguide device 24 may be placed, for example, at mid-span of the fiber 22. A laser 23 may provide a continuous wave laser beam as a pump signal at wavelength λ1 to produce the FWM effect. That laser may be fabricated on the same substrate as the waveguide device or provided separately. The pump signal Al and the lower power input signal centered at λ2 carrying the data 20 are co-linearly coupled into the silicon waveguide device 24. Due to the nonlinear interaction between these beams (degenerated four wave mixing), a new signal, which is the optical phase conjugate of the input signal, centered at wavelength λ3 is produced and exits the waveguide together with the pump and signal beams.

The wavelengths of the pump 23, the input signal.λ2 and the converted conjugate signal λ3 satisfy the following relation: 1/λ3=2/λ1−1/λ2. An optical filter 26 may be used to separate the converted signal from the pump and the input signal. The newly generated signal at λ3 contains the optical phase conjugate of the original input signal λ2. That is, the higher frequency components in the original signal λ2 become lower frequency components in the newly generated signal λ3 and vice-versa. Therefore, the frequency components that were traveling slowly in the first half-span are now the ones traveling faster in the second half-span, thus compensating for accumulated chromatic dispersion.

FIG. 3 is a graph illustrating the measured spectrum of the FWM signals, where λ1 is the pump signal, λ2 is the input signal, and λ3 is the optical phase conjugate signal with side-bands associated to the 40 Gb/s non-return to zero (NRZ) modulation. As shown by arrows 30 and 32, wavelength components in the original and phase conjugated signals are swapped. Thus, as shown in FIG. 2 after the second X km of fiber after the silicon waveguide device 24, original data 20 may be recovered as received data 28. In the experiment, an NRZ data (pseudo-random-bit-sequence) of pattern length of 2³¹−1 was transmitted at 40 Gb/s through 120 km and 320 km length of fiber using silicon based OPC at mid-span. The data are correctly recovered in both cases.

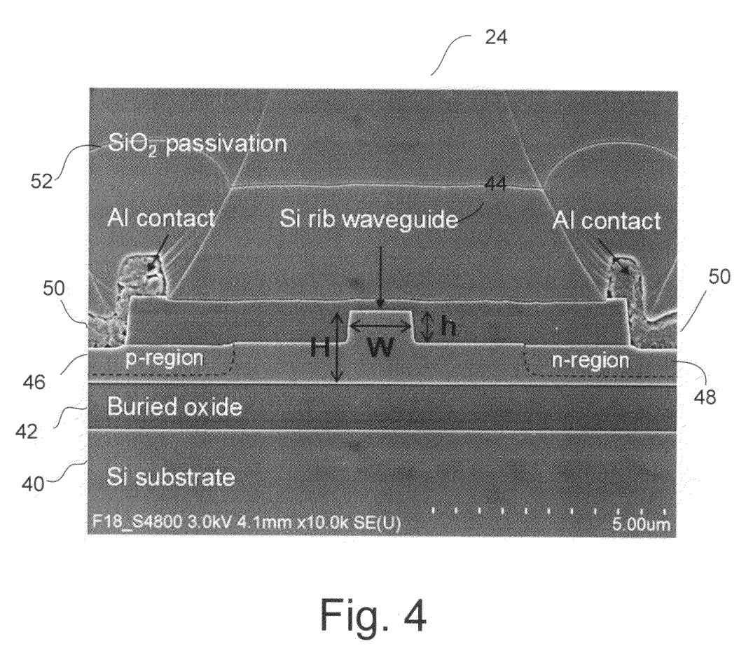

FIG. 4 shows one example of a suitable silicon waveguide device 24 that may be placed mid-span of a long haul fiber. The waveguide device comprises an Si substrate 40 and a buried oxide layer 42. On either side of the Si waveguide rib 44 is a p-region 46 and an n-region 48 each having an aluminum or other conductive material contact 50 thereon. This p-i-n diode structure, when reverse biased, reduces the non-linear optical losses of the silicon waveguide and therefore enables higher efficiency of the non-linear optical conversion process. In this example, the dimensions of the waveguide are W=1.5 um, H=1.55 um, and h=0.7 um. A SiO₂ passivation layer 52 may top the waveguide device 24. Of course this particular configuration and dimensions are offered by way of example and other embodiments are possible.

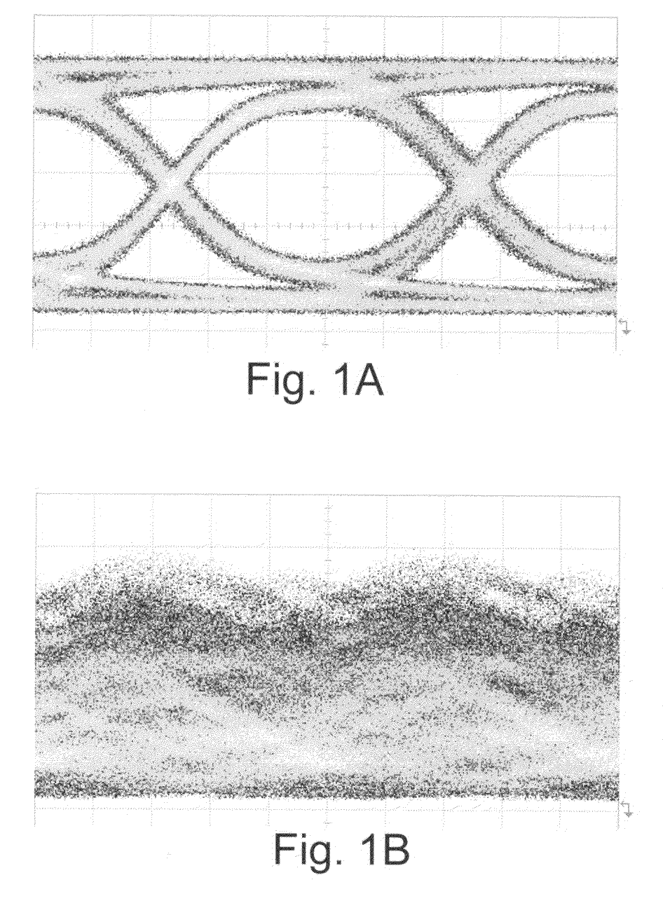

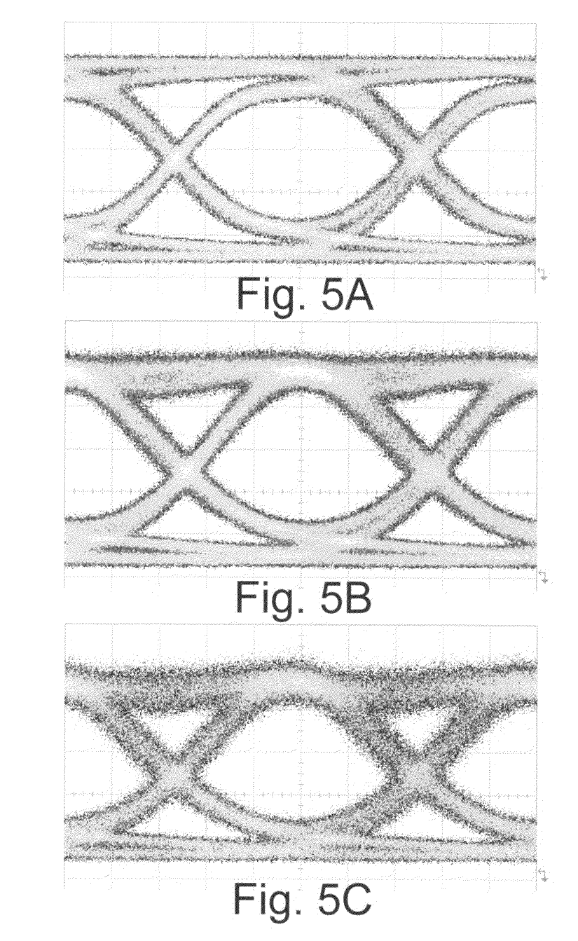

FIGS. 5A, 5B, and 5C illustrate the chromatic dispersion compensation benefits of embodiments of the invention. FIG. 5A is an eye diagram of the 40 Gbps PRBS input signal before transmission as shown in FIG. 1A.

FIG. 5B is the same signal as shown in FIG. 5A after 120 km of transmission using optical phase conjugation according to one embodiment of the invention. As illustrated, very little distortion is present in the signal after 120 km.

FIG. 5C is the same signal as shown in FIG. 5A after 320 km of transmission using optical phase conjugation showing minimal distortion and the data in the signal is still fully recoverable. Compare this to FIG. 1B, where the signal without chromatic dispersion compensation is unrecoverable after only 20 km. Further, silicon waveguides such as used here can operate at room temperature, and are particularly well suited for OPC applications since they have high conversion efficiency, high damage threshold, and are highly reliable and easy to fabricate.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus to reduce chromatic dispersion, comprising:
a. silicon waveguide;
a first input to receive a pump signal centered at a wavelength λ1;
a second input to receive a data signal centered at a second wavelength λ2, the pump signal and the data signal being co-linearly coupled into the silicon Waveguide; and
an output to output a signal including a phase conjugated signal of the data signal centered at a third wavelength λ3.

2. The apparatus as recited in claim 1, wherein the output signal satisfies 1/λ3=2/λ1−1/λ2.

3. The apparatus as recited in claim 1, wherein the output signal further comprises the data signal and the pump signal.

4. The apparatus as recited in claim 3 further comprising:
a filter to filter out the data signal and the pump signal.

5. The apparatus as recited in claim 1 wherein the silicon waveguide is located approximately half-span of a fiber link.

6. The apparatus as recited in claim 1 wherein higher frequency components in the data signal λ2 correspond to lower frequency components in the phase conjugated signal centered at λ3.

7. The apparatus as recited in claim 1 wherein a laser to produce the pump signal is included on a same substrate as the silicon waveguide.

8. A method for reducing chromatic dispersion, comprising:
inputting a pump signal centered at a first wavelength λ1 into a silicon waveguide;
inputting a data signal centered at a second wavelength λ2, the pump signal and the data signal being co-linearly coupled into the silicon waveguide; and
outputting a signal including a phase conjugated signal of the data signal centered at a third wavelength λ3.

9. The method as recited in claim 8, wherein the output signal satisfies 1/λ3=2/λ1−1/λ2.

10. The method as recited in claim 8 further comprising:
filtering the output signal to remove the pump signal and the data signal.

11. The method as recited in claim 8 further comprising:
placing the silicon waveguide at approximately half-span of a fiber link.

12. The method as recited in claim 8 wherein higher frequency components in the data signal λ2 correspond to lower frequency components in the phase conjugated signal centered at λ3.

13. The method as recited in claim 8 further comprising:
fabricating a laser to produce the pump signal on a same substrate as the silicon waveguide.
